(19) United States
(12) Patent Application Publication
(10) Pub. No.: US 2025/0117448 A1
(43) Pub. Date: Apr. 10, 2025

(54) SYSTEMS AND METHODS FOR DYNAMICALLY SECURING TRANSMITTED DATA

(71) Applicant: Capital One Services, LLC, McLean, VA (US)

(72) Inventor: Shahalam BAIG, Rochester, NY (US)

(73) Assignee: Capital One Services, LLC, McLean, VA (US)

(21) Appl. No.: 18/905,174

(22) Filed: Oct. 3, 2024

Related U.S. Application Data
(60) Provisional application No. 63/587,891, filed on Oct. 4, 2023.
(60) Provisional application No. 63/665,485, filed on Jun. 28, 2024.
(60) Provisional application No. 63/683,063, filed on Aug. 14, 2024.

(51) Int. Cl. G06F 21/10; G06F 40/20

(52) U.S. Cl. CPC G06F 21/101; G06F 40/20

(57) ABSTRACT

Described are systems and methods for dynamically securing transmitted data, including accessing a first secure application, receiving, via the first secure application, a data set, wherein the data set includes at least one of text data, image data, video data, or audio data, determining, via a first application server associated with the first secure application, a content element associated with the data set, wherein the content element includes sensitive information, generating, via the first application server, media based on the sensitive information, wherein the media is encrypted to include digital rights management (“DRM”) protection, transmitting, to a second secure application associated with a second user device, the media, and causing to output the media via a graphical user interface (“GUI”) associated with the second user device.

### CROSS-REFERENCE TO RELATED APPLICATION(S)

This application claims the benefit of pending U.S. Provisional Patent Application No. 63/587,891, filed on Oct. 4, 2023, pending U.S. Provisional Patent Application No. 63/665,485, filed on Jun. 28, 2024, and pending U.S. Provisional Patent Application No. 63/683,063, filed on Aug. 14, 2024, all of which are incorporated herein by reference in their entireties.

### TECHNICAL FIELD

Various embodiments of this disclosure relate generally to dynamically securing transmitted data and, more particularly, to systems and methods for dynamically securing transmitted data via a secure application.

### BACKGROUND

Messaging applications (or instant messaging applications) are often used to send and receive messages that include text, images, audio data, or video. In some cases, the messages may include sensitive or confidential information (e.g., personally identifiable information (PII), financial information, medical information, etc.). For example, a person A may use a messaging application installed on a mobile phone to send a message that includes financial information to a person B. The person B may use a laptop on which the messaging application is installed to receive and view the message. To protect the financial information, the messaging application may encrypt the message when the message is sent from the person A to the person B. However, if the person A wishes to prevent the person B from sharing or recording the message using, for example, a screensharing application, a remote desktop application, or a screenshotting application installed on the person B's laptop, the messaging application may not be able to prevent the person B from doing so.

This disclosure is directed to addressing one or more of the above-referenced challenges. The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY OF THE DISCLOSURE

According to certain aspects of the disclosure, methods and systems are disclosed for dynamically securing transmitted data.

In one aspect, a method for dynamically securing transmitted data is disclosed. The method may include accessing, via a first user device, a first secure application, receiving, via the first secure application, a data set, wherein the data set includes at least one of text data, image data, video data, or audio data, determining, via a first application server associated with the first secure application, a content element associated with the data set, wherein the content element includes sensitive information, generating, via the first application server, media based on the sensitive information, wherein the media is encrypted to include digital rights management (“DRM”) protection, transmitting, to a second secure application associated with a second user device, the media, and causing to output the media via a graphical user interface (“GUI”) associated with the second user device.

In another aspect, a system is disclosed. The system may include at least one memory storing instructions and at least one processor operatively connected to the memory, and configured to execute the instructions to perform operations for dynamically securing transmitted data. The operations may include accessing, via a first user device, a first secure application, receiving, via the first secure application, a data set, wherein the data set includes at least one of text data, image data, video data, or audio data, determining, via a first application server associated with the first secure application, a content element associated with the data set, wherein the content element includes sensitive information, generating, via the first application server, media based on the sensitive information, wherein the media is encrypted to include digital rights management (“DRM”) protection, transmitting, to a second secure application associated with a second user device, the media, and causing to output the media via a graphical user interface (“GUI”) associated with the second user device.

In another aspect, a method for dynamically securing transmitted data is disclosed. The method may include accessing, via a first user device, a first secure application via a first data transmission application, wherein the first secure application is embedded in the first data transmission application, receiving, via the first secure application, a data set, wherein the data set includes at least one of text data, image data, video data, or audio data, determining, via a first application server associated with the first secure application, a content element associated with the data set, wherein the content element includes sensitive information, generating, via the first application server, media based on the sensitive information, wherein the media is encrypted to include digital rights management (“DRM”) protection, transmitting, to a second secure application associated with a second user device, the media, determining, via a second application server associated with the second secure application, whether an indication of digital extraction is present, wherein the second secure application is embedded in a second data transmission application, and upon determining via the second application server the indication of digital extraction is not present, causing to output the media via a graphical user interface (“GUI”) associated with the second user device.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts an exemplary environment for dynamically securing transmitted data, according to one or more embodiments.

FIGS. 2A-2B depict exemplary methods for dynamically securing transmitted data, according to one or more embodiments.

FIG. 3 depicts a simplified functional block diagram of a computer, according to one or more embodiments.

### DETAILED DESCRIPTION OF EMBODIMENTS

Reference to any particular activity is provided in this disclosure only for convenience and not intended to limit the disclosure. The disclosure may be understood with reference to the following description and the appended drawings, wherein like elements are referred to with the same reference numerals.

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features, as claimed.

In this disclosure, the term “based on” means “based at least in part on.” The singular forms “a,” “an,” and “the” include plural referents unless the context dictates otherwise. The term “exemplary” is used in the sense of “example” rather than “ideal.” The terms “comprises,” “comprising,” “includes,” “including,” or other variations thereof, are intended to cover a non-exclusive inclusion such that a process, method, or product that comprises a list of elements does not necessarily include only those elements, but may include other elements not expressly listed or inherent to such a process, method, article, or apparatus. The term “or” is used disjunctively, such that “at least one of A or B” includes, (A), (B), (A and A), (A and B), etc. Relative terms, such as, “substantially,” “about,” “approximately,” and “generally,” are used to indicate a possible variation of ±10% of a stated or understood value.

It will also be understood that, although the terms first, second, third, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

The term “user” or the like may refer to a person authorized to access an account, attempting to access an account, etc. As used herein, the term “social engineer” may be a person or entity who seeks to manipulate a target (e.g., a customer or employee of an organization) into divulging sensitive information that may be used for fraudulent purposes. That is, a social engineer is a person or entity who engages in social engineering.

As used herein, the phrase “media content” may represent a browser, a website, a webpage, etc. As used herein, the phrase “content element” may represent text data (e.g., letters, numbers, symbols, metadata, or alt text), image data (e.g., an image, a graphic, a sequence of image frames, or a video), audio data (e.g., a sequence of audio frames), or video data (e.g., a sequence of image frames). Further, a content element may represent data included in, or referred by, an HTML element of an HTML page corresponding to (or representing) the webpage. For example, a content element may be included in HTML used to structure the website, such as a Document Object Model (“DOM”), Cascading Style Sheets (“CSS”), etc. In some aspects, the content element may include or represent sensitive or confidential information (e.g., that may be displayed on a webpage (or webpage(s), website(s), portal(s) or application(s), etc.).

As used herein, the phrase “sensitive information” or “sensitive data” may refer to data that is intended for, or restricted to the use of, one or more users or entities (e.g., a user 105, an organization associated with a DRM-protection system 131, etc.). Moreover, sensitive data may represent data that is personal, private, confidential, privileged, secret, classified, or in need of protection, for example. Sensitive information may include personally identifiable information (“PII”) (e.g., a name, an address, a phone number, a social security number, etc.), financial information (e.g., an account number, an account balance, debits, credits, etc.), medical information (e.g., test results, appointments, medications, etc.), business information (e.g., proprietary information, trade secrets, etc.), government information (e.g., classified or secret information), any information a user may wish to not be shared with a third party, etc.

The phrase “hypertext markup language,” “HTML,” or the like may refer to a standardized system for tagging text files to achieve font, color, graphic, or hyperlink effects on World Wide Web pages. The phrase “HTML element” may represent a component of an HTML page, and may include, for example, a start tag and end tag, and as noted above, a content element or a reference to a content element (e.g., link, hyperlink, address, or path to a content element). Further, in some embodiments, an HTML element may include one or more HTML elements (e.g., nested HTML elements). As used herein, the term “pixel” may refer to the smallest element (or unit) of a display screen that can be programmed by (or manipulated through) software. In some embodiments, a pixel may include sub-pixels (e.g., a red sub-pixel, a green sub-pixel, and a blue sub-pixel) that emit light to create a color displayed on the display screen. In some aspects, the color may be included in, or represent, text data, image data, or video data presented on the display screen.

As used herein, the phrase “digital extraction” may refer to any process of copying content (e.g., audio, video, text, image, etc.), such as ripping, screensharing, screenshotting, etc. As used herein, the term “screenshare” or “screen share” may refer to a real time or near real time electronic transmission of data displayed on a display screen of a user's computing device to one or more other computing devices. The term “screensharing” or “screen sharing” and the phrase “being screenshared” or “being screen shared” may refer to performing a screenshare. In some aspects, screensharing may be performed using a screensharing application (e.g., a video or web conferencing application such as Zoom®, Microsoft's Teams®, or the like, or a remote desktop application such as Microsoft Remote Desktop, Chrome Remote Desktop, or the like). As used herein, the term “screenshot” or “screen shot” may represent an image of data displayed on a display screen of a computing device, where the image may be captured or recorded. The term “screenshotting” or “screen shotting” and the phrase “being screenshotted” or “being screen shotted” may refer to capturing or recording a screenshot. In some aspects, screenshotting may be performed using a screenshotting application (e.g., the Snipping Tool in Microsoft's Windows 11 or an application accessed using a Print Screen key of a keyboard or keypad).

In an exemplary use case, this technology may be used to prevent (or protect) sensitive or confidential information (e.g., financial, business, medical, etc.) that is sent via text message from being screenshared or screenshotted on a receiving device. The text message may be sent using messaging applications such as iMessage, WhatsApp, Snapchat, etc. Further, this technology may be incorporated in Facebook add-ons, Gmail extensions, browser extensions, mobile applications, or web applications.

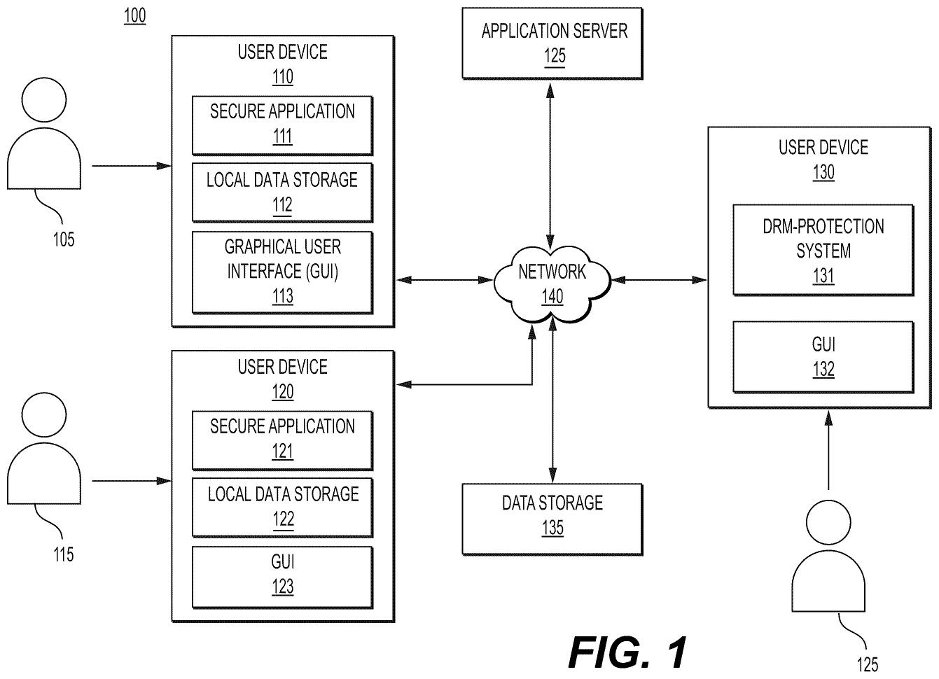

FIG. 1 depicts an exemplary environment 100 for dynamically securing transmitted data, according to one or more embodiments. In some aspects, the environment 100 may be an embodiment of (i) environment 100 described in U.S. Provisional Application 63/587,891, filed on Oct. 4, 2023, (ii) environment 100 described in U.S. Provisional Application 63/665,485, filed Jun. 28, 2024, or (iii) environment 100 described in U.S. Provisional Application 63/683,063, filed Aug. 14, 2024, where each of these U.S. provisional applications is incorporated by reference herein in its entirety. Environment 100 may include one or more aspects that may communicate with each other over a network 140, including, e.g., at least one memory storing instructions, and at least one processor operatively connected to the at least one memory and configured to execute the instructions to perform operations for dynamically securing transmitted data.

In some embodiments, a first user (e.g., a user 105) may interact with a first user device (e.g., a user device 110) such that a secure application (e.g., a secure application 111) may be accessed. User 105 may be an individual attempting to transmit data via secure application 111. In some embodiments, a second user (e.g., a user 115) may interact with a second user device (e.g., a user device 120) such that a secure application (e.g., a secure application 121) may be accessed. User 115 may be an individual attempting to receive data via secure application 121. In some embodiments, a third user (e.g., a user 125) may interact with a third user device (e.g., a user device 130) such that a digital rights management (“DRM”)-protection system (e.g., a DRM-protection system 131) may be accessed. User 125 may be an individual attempting to protect, monitor, etc. data via DRM-protection system 131.

In some embodiments, each of user devices 110, 120, 130 may be a computer system, e.g., a desktop computer, a laptop computer, a tablet, a smart cellular phone, a smart watch or other electronic wearable, etc. In some embodiments, user devices 110, 120, 130 may include one or more electronic applications, e.g., a program, plugin, browser extension, etc., installed on a memory of user device 110, 120, 130. In some embodiments, the electronic applications may be associated with one or more of the other components in the environment 100. For example, as discussed herein, secure applications 111, 121 may be applications downloaded on user devices 110, 120, respectively.

User devices 110, 120 may be configured to interact with each other and at least one of user device 130, application server 125, a data storage 135, etc. Each of user devices 110, 120 may include a secure application (e.g., secure application 111 and secure application 121, respectively), server local data storage (e.g., local data storage 112 and local data storage 122, respectively), a graphical user interface (“GUI”) (e.g., GUI 113 and GUI 123, respectively), etc.

Each of user devices 110, 120—or the one or more aspects of user devices 110, 120—may be configured to obtain data from or transmit data to one or more aspects of environment 100. For example, user device 110 may be configured to receive data from one or more aspects of environment 100, e.g., from secure application 111, local data storage 112, GUI 113 (e.g., via one or more inputs from user 105), user device 120, secure application 121, local data storage 122, a GUI 123 (e.g., via one or more inputs from user 115), an application server 125, user device 130, DRM-protection system 131, a GUI 132 (e.g., via one or more inputs from user 125), data storage 135, etc. User device 110 may be configured to transmit data to one or more aspects of environment 100, e.g., to secure application 111, local data storage 112, GUI 113, user device 120, secure application 121, local data storage 122, a GUI 123, an application server 125, user device 130, DRM-protection system 131, a GUI 132, data storage 135, etc.

Further, user device 120 may be configured to receive data from one or more aspects of environment 100, e.g., from user device 110, secure application 111, local data storage 112, GUI 113 (e.g., via one or more inputs from user 105), secure application 121, local data storage 122, GUI 123 (e.g., via one or more inputs from user 115), application server 125, user device 130, DRM-protection system 131, GUI 132 (e.g., via one or more inputs from user 125), data storage 135, etc. User device 120 may be configured to transmit data to one or more aspects of environment 100, e.g., to user device 110, secure application 111, local data storage 112, GUI 113, secure application 121, local data storage 122, a GUI 123, application server 125, user device 130, DRM-protection system 131, GUI 132, data storage 135, etc.

Secure application 111, 121 may be configured to facilitate dynamically securing transmitted data. Secure application 111, 121 may be an application (e.g., a cell phone application, an e-mail application, etc.), a plug-in (e.g., a website plug-in), etc. For example, secure application 111, 121 may be an application on a user device (e.g., user device 110, user device 120, etc.) that may be downloaded from an application database (e.g., an application store). In a further example, secure application 111, 121 may be a plug-in downloaded from a plug-in database (e.g., a plug-in store). In another example, secure application 111 may be a website plug-in and secure application 121 may be a cell phone application. Secure application 111, 121 may be configured to operate in conjunction with a data transmission application (e.g., a messaging application, a social media application, etc.).

Secure application 111, 121 may be configured to retrieve or request at least one data set from other aspects of environment 100. In some embodiments, secure application 111, 121 may be configured to access a data storage application (e.g., local data storage 112, 122, respectively). As discussed in herein, local data storage 112, 122 may include an application on a user device, such as an image storage application, a notes application, a data copying application or function, a financial institution application, etc. For example, a user (e.g., user 105) may provide an input via GUI 113 requesting an image from local data storage 112 (e.g., an image storage application) of user device 110. Secure application 111, 121 may be configured to request access to the image storage application, retrieve the requested image, or cause the transmission of the requested image from the image storage application to application server 125, data storage 135, etc. In a further example, a user (e.g., user 115) may provide an input via GUI 123 to retrieve (e.g., copy) text from local data storage 122 (e.g., a notes application) of user device 120. Secure application 121 may be configured to access the notes application, retrieve the requested text, or cause the transmission of the text from the notes application to application server 125, data storage 135, etc.

GUI 113, 123 may be configured to obtain at least one user input. GUI 113, 123 may receive the at least one user input via a user (e.g., user 105, user 115, etc.) interacting with GUI 113, 123 (e.g., by clicking, typing, indicating, highlighting, selecting, etc.). GUI 113, 123 may be configured to transmit the at least one user input to other aspects of environment 100, as discussed below.

GUI 113, 123 may be configured to cause to output media, modified media, alert(s), etc. GUI 113, 123 may be configured to output any number or any combination of media (e.g., first media, second media, third media, etc.), modified media (e.g., first modified media, second modified media, third modified media, etc.), alert(s) (e.g., a first alert, a second alert, etc.), etc.

GUI 113, 123 may be configured to receive data (e.g., to cause to output, such as media, modified media, alert(s), etc.) from other aspects of environment 100. For example GUI 113 may be configured to receive data from user device 110, secure application 111, local data storage 112, user device 120, secure application 121, local data storage 122, GUI 123 (e.g., via one or more inputs from user 115), application server 125, user device 130, DRM-protection system 131, GUI 132 (e.g., via one or more inputs from user 125), data storage 135, etc. GUI 113 may be configured to transmit data (e.g., at least one user input) to other aspects of environment 100, such as to user device 110, secure application 111, local data storage 112, user device 120, secure application 121, local data storage 122, GUI 123, application server 125, user device 130, DRM-protection system 131, GUI 132, data storage 135, etc.

Further, GUI 123 may be configured to receive data from user device 110, secure application 111, local data storage 112, GUI 113 (e.g., via one or more inputs from user 105), user device 120, secure application 121, local data storage 122, application server 125, user device 130, DRM-protection system 131, GUI 132 (e.g., via one or more inputs from user 125), data storage 135, etc. GUI 113 may be configured to transmit data (e.g., at least one user input) to other aspects of environment 100, such as to user device 110, secure application 111, local data storage 112, GUI 113, user device 120, secure application 121, local data storage 122, application server 125, user device 130, DRM-protection system 131, GUI 132, data storage 135, etc.

Application server 125 may be configured to obtain at least one data set, e.g., from other aspects of environment 100. The at least one data set (e.g., a first data set, a second data set, etc.) may include at least one of text data, image data, video data, or audio data. In some embodiments, application server 125 may be configured to receive a natural language prompt (e.g., from GUI 113 via an input by user 105, from GUI 123 via an input by user 115, etc.). For example, a user (e.g., user 105) may input a natural language prompt (e.g., text, audio converted to text, etc.) via a GUI (e.g., GUI 113). The natural language prompt inputted by user 105 may be transmitted to and received by application server 125 as a data set. In a further example, a user (e.g., user 115) may input a natural language prompt (e.g., text, audio converted to text, etc.) via a GUI (e.g., GUI 123). The natural language prompt inputted by user 115 may be transmitted to and received by application server 125 as a data set.

Application server 125 may be configured to determine a content element associated with the at least one data set. As discussed herein, the content element may include sensitive information, such as personally identifiable information (“PII”) (e.g., a name, an address, a phone number, a social security number, etc.), financial information (e.g., an account number, an account balance, debits, credits, etc.), medical information (e.g., test results, appointments, medications, etc.), business information (e.g., proprietary information, trade secrets, etc.), government information (e.g., classified or secret information), any information a user may wish to not be shared with a third party, etc. In some embodiments, application server 125 may be configured to determine the content element associated with the at least one data set using a trained machine learning model. For example, application server 125 may be configured to predict the at least one data set includes a content element (or sensitive information) based on the at least one data set, at least one user input, etc.

In some embodiments, application server 125 may be configured to determine the content element by analyzing the at least one data set. Application server 125 may analyze the at least one data set based on the data set format (e.g., text, image, video, audio, etc.), the data set source (e.g., natural language prompt, a data storage system, etc.), or any other relevant aspect for analysis. For example, where the data set is an image, application server 125 may be configured to utilize optical character recognition (“OCR”) to convert the image to machine-readable text; application server 125 may analyze the machine-readable text for sensitive information.

Application server 125 may be configured to generate media. The media may be an image (e.g., a still image), a video (e.g., a single frame-looped video), etc. The media may be one (1) pixel by one (1) pixel. The media may be substantially transparent. For example, the media may be about 70%-80%, about 80%-90%, about 90%-99%, etc. transparent. It may be advantageous for the media to be less than 100% transparent because the DRM protection techniques may fail to completely render media that is 100% transparent, and therefore may fail to effectively block the 100% transparent media. Application server 125 may be configured to generate media based on one or more of the data set, the content element, the sensitive information, etc. For example, application server 125 may be configured to generate a single frame-looped video based on the sensitive information. In some embodiments, application server 125 may be configured to generate media by encrypting the media to include digital rights management (“DRM”) protection. Generating the media with DRM protections may be configured to restrict the sensitive information from being shared or recorded (or captured) by screen sharing application(s), remote desktop application(s), or screenshotting application(s), for example.

Application server 125 may be configured to modify the media, e.g., the DRM-encrypted media. The media may be modified such that the sensitive information (e.g., of the data set, the content element, etc.) may be made substantially not visible. In some embodiments, application server 125 may be configured to modify the media based upon receipt of an indication of digital extraction (discussed in more detail below). The media may be modified based on the format of the data set, content element, sensitive information, etc. (e.g., from substantially transparent to substantially opaque, from a video to an image, from a single frame-looped video to an image, etc.). For example, application server 125 may be configured to convert a substantially transparent DRM-encrypted media (e.g., a substantially transparent single frame-looped video) to substantially opaque modified DRM-encrypted media (e.g., a substantially opaque single frame-looped video). In another example, application server 125 may be configured to convert a looped-video DRM-encrypted media (e.g., a single frame-looped video) to an image to generate a modified DRM-encrypted media (e.g., a paused single frame-looped video). Application server 125 may be configured to transmit the modified media (e.g., the modified DRM-encrypted media) to other aspects of environment 100, as discussed herein.

Application server 125 may be configured to detect, analyze, or transmit (e.g., to user device 110, 120, 130, DRM-protection system 131, etc.) an indication of digital extraction (e.g., screensharing, screenshotting, screen capture, etc.). For example, application server 125 may be configured to transmit the indication of digital extraction to user device 120 (e.g., to secure application 121). In another example, application server 125 may be configured to transmit the indication of digital extraction to user device 110 (e.g., to secure application 111).

In some embodiments, application server 125 may be configured to receive the indication of digital extraction from other aspects of environment 100. For example, application server 125 may be configured to receive the indication of digital extraction from user device 120 (e.g., from secure application 121), user device 130 (e.g., DRM-protection system 131), data storage 135, etc. In another example, application server 125 may be configured to receive the indication of digital extraction from user device 110 (e.g., from secure application 111), user device 130 (e.g., DRM-protection system 131), data storage 135, etc.

Application server 125 may be configured to determine the presence of the indication of digital extraction. In some embodiments, application server 125 may be configured to detect indirect measures of digital extraction to determine the presence of the indication of digital extraction, e.g., via user input(s), enabled setting(s) on user device 110, 120, other applications concurrently operating on user device 110, 120, etc. In some embodiments, application server 125 may be configured to determine the presence of digital extraction based on indirect measures. Indirect measures of digital extraction may include historical user behavior (e.g., mouse movements by the user), interaction patterns (e.g., a comparison of how the user has historically interacted with a webpage and how the user is now interacting with the webpage), screen resolution changes, user input(s), etc. For example, application server 125 may be configured to detect user input(s) that may be indicative of screenshotting, such as simultaneously pressing and releasing the lock button and the volume up button on a cellular phone. In another example, application server 125 may be configured to determine a screen recording feature is enabled in the settings of user device 110, 120. Application server 125 may determine the enabled screen recording feature is indicative of digital extraction.

Application server 125 may be configured to generate at least one alert. In some embodiments, application server 125 may be configured to generate the at least one alert based on at least one of the indication of digital extraction, the data set, the content element, the sensitive information, the media, the modified media, etc. Application server 125 may be configured to transmit the at least one alert to other aspects of environment 100, as discussed herein. In some embodiments, application server 125 may be configured to generate the at least one alert based on an intended recipient individual (e.g., user 105, user 115, user 125, etc.). The at least one alert may include any suitable information, such as a message (e.g., a message to user 105, a message to user 115, a message to user 125, etc.), the indication of digital extraction, etc.

In some embodiments, application server 125 may be configured to generate a first alert. For example, application server 125 may be configured to generate a first alert for user 115. The first alert may include a message for user 115, for example, “Your information may be compromised,” etc. Application server 125 may be configured to transmit the first alert to a user device associated with user 115 (e.g., to user device 120 for output via GUI 123). In another example, application server 125 may be configured to generate a first alert for user 105. The first alert may include a message for user 105, for example, “Your information may be compromised,” etc. Application server 125 may be configured to transmit the first alert to a user device associated with user 105 (e.g., to user device 110 for output via GUI 113). In further example, application server 125 may be configured to generate a first alert for aspects of environment 100, such as for internal use by application server 125.

In some embodiments, application server 125 may be configured to generate a second alert. For example, application server 125 may be configured to generate a second alert for user 125. The second alert may include a message for user 125, for example, “Customer A's information may be compromised,” etc. Application server 125 may be configured to transmit the second alert to a user device associated with user 125 (e.g., to user device 130 for output via GUI 132, to user device 130 for analysis via DRM-protection system 131, etc.).

Application server 125 may be configured to receive data from other aspects of environment 100. For example application server 125 may be configured to receive data from user device 110, secure application 111, local data storage 112, user device 120, secure application 121, local data storage 122, GUI 123 (e.g., via one or more inputs from user 115), user device 130, DRM-protection system 131, GUI 132 (e.g., via one or more inputs from user 125), data storage 135, etc. Application server 125 may be configured to transmit data to other aspects of environment 100, such as to user device 110, secure application 111, local data storage 112, user device 120, secure application 121, local data storage 122, GUI 123, user device 130, DRM-protection system 131, GUI 132, data storage 135, etc.

User device 130 may interact with at least one of user device 110, user device 120, application server 125, data storage 135, etc. User device 130 may include DRM-protection system 131 or GUI 132. User device 130—or the one or more aspects of user device 130, e.g., DRM-protection system 131, GUI 132, etc.—may be configured to obtain data from or transmit data to one or more aspects of environment 100. User device 130 may be configured to receive data from one or more aspects of environment 100, e.g., from user device 110, secure application 111, local data storage 112, GUI 113 (e.g., via one or more inputs from user 105), user device 120, secure application 121, local data storage 122, GUI 123 (e.g., via one or more inputs from user 115), application server 125, DRM-protection system 131, GUI 132 (e.g., via one or more inputs from user 125), data storage 135, etc. User device 130 may be configured to transmit data to one or more aspects of environment 100, e.g., to user device 110, secure application 111, local data storage 112, GUI 113, user device 120, secure application 121, local data storage 122, GUI 123, application server 125, DRM-protection system 131, GUI 132, data storage 135, etc.

User device 130 may include a DRM-protection system 131 or a GUI 132. DRM-protection system 131 may be configured to implement at least one protective action. The at least one protective action may be configured to protect (or safeguard) a content element, sensitive information, etc. The at least one protective action may include at least one of pausing, locking, canceling, etc. an account (e.g., a financial account, etc.) associated with the sensitive information, receiving or transmitting the at least one alert (e.g., to GUIs 113, 123, 132 to cause to output), etc. In some embodiments, DRM-protection system 131 may be configured to implement the at least one protective action based on at least one of the indication of digital extraction, the at least one alert (e.g., the first alert, the second alert, etc.), etc. For example, where the content element represents a checking account number, DRM-protection system 131 may be configured to lock (or freeze) the checking account associated with the checking account number upon receipt of the second alert.

DRM-protection system 131 maybe configured to obtain data from one or more aspects of environment 100. For example, DRM-protection system 131 may be configured to receive data from user device 110, secure application 111, local data storage 112, GUI 113 (e.g., via one or more inputs from user 105), user device 120, secure application 121, local data storage 122, GUI 123 (e.g., via one or more inputs from user 115), application server 125, user device 130, GUI 132 (e.g., via one or more inputs from user 125), data storage 135, etc. DRM-protection system 131 may be configured to transmit data to one or more aspects of environment 100, e.g., to user device 110, secure application 111, local data storage 112, GUI 113, user device 120, secure application 121, local data storage 122, GUI 123, application server 125, user device 130, GUI 132, data storage 135, etc.

GUI 132 may be configured to output alert(s), etc. For example, GUI 132 may be configured to output a second alert. User 125 may interact with the second alert via GUI 132. GUI 132 may be configured to output any number or any combination of: data set(s) (e.g., a first data set, a second data set, etc.), media (e.g., first media, second media, third media, etc.), modified media (e.g., first modified media, second modified media, third modified media, etc.), alert(s) (e.g., a first alert, a second alert, etc.), etc.

GUI 132 may be configured to receive data (e.g., data set(s), media, modified media, alert(s), etc.) from other aspects of environment 100, such as from user device 110, secure application 111, local data storage 112, GUI 113 (e.g., via one or more inputs from user 105), user device 120, secure application 121, local data storage 122, GUI 123 (e.g., via one or more inputs from user 115), application server 125, user device 130, DRM-protection system 131, data storage 135, etc. GUI 132 may be configured to transmit data (e.g., at least one user input) to other aspects of environment 100, such as to user device 110, secure application 111, local data storage 112, GUI 113, user device 120, secure application 121, local data storage 122, GUI 123, application server 125, user device 130, DRM-protection system 131, data storage 135, etc.

Data storage 135 may be any data storage system, such as a third-party data storage system, a hard drive (e.g., an internal hard drive, an external hard drive, etc.), etc. Data storage 135 may be configured to receive for storage, store, retrieve from the storage, or transmit from the storage: data set(s) (e.g., a first data set, a second data set, etc.), media (e.g., first media, second media, etc.), modified media (e.g., first modified media, second modified media, etc.), alert(s) (e.g., the first alert, the second alert, etc.), etc. Data storage 135 may be configured to receive data from one or more aspects of environment 100, e.g., from user device 110, secure application 111, local data storage 112, GUI 113 (e.g., via one or more inputs from user 105), user device 120, secure application 121, local data storage 122, GUI 123 (e.g., via one or more inputs from user 115), application server 125, user device 130, DRM-protection system 131, GUI 132 (e.g., via one or more inputs from user 125), etc. Data storage 135 may be configured to transmit data to one or more aspects of environment 100, e.g., to user device 110, secure application 111, local data storage 112, GUI 113, user device 120, secure application 121, local data storage 122, GUI 123, application server 125, user device 130, DRM-protection system 131, GUI 132, etc.

One or more of the components in FIG. 1 may communicate with each other or other systems, e.g., across network 140. In some embodiments, network 140 may connect one or more components of environment 100 via a wired connection, e.g., a USB connection between user device 110 and data storage 135. In some embodiments, network 140 may connect one or more aspects of environment 100 via an electronic network connection, for example a wide area network (WAN), a local area network (LAN), personal area network (PAN), a content delivery network (CDN), or the like. In some embodiments, the electronic network connection includes the internet, and information and data provided between various systems occurs online. “Online” may mean connecting to or accessing source data or information from a location remote from other devices or networks coupled to the Internet. Alternatively, “online” may refer to connecting or accessing an electronic network (wired or wireless) via a mobile communications network or device. The Internet is a worldwide system of computer networks—a network of networks in which a party at one computer or other device connected to the network may obtain information from any other computer and communicate with parties of other computers or devices. The most widely used part of the Internet is the World Wide Web (often-abbreviated “WWW” or called “the Web”). A “website page,” a “portal,” or the like generally encompasses a location, data store, or the like that is, for example, hosted or operated by a computer system so as to be accessible online, and that may include data configured to cause a program such as a web browser to perform operations such as send, receive, or process data, generate a visual display or an interactive interface, or the like. In any case, the connections within the environment 100 may be network, wired, any other suitable connection, or any combination thereof.

Although depicted as separate components in FIG. 1, it should be understood that a component or portion of a component in the environment 100 may, in some embodiments, be integrated with or incorporated into one or more other components. For example, application server 125 may be integrated in secure application 111, 121. In another example, data storage 135 may be integrated in user device 110, 120, or 130. In some embodiments, operations or aspects of one or more of the components discussed above may be distributed amongst one or more other components, e.g., application server 125, data storage 135, etc.

In some embodiments, some of the components of environment 100 may be associated with a common entity, while others may be associated with a disparate entity. For example, secure application 111 and secure application 121 may be associated with a common entity (e.g., an entity with which user 105 and user device 110 have accounts) while data storage 135 may be associated with a third party (e.g., a provider of data storage services). Any suitable arrangement or integration of the various systems and devices of the environment 100 may be used.

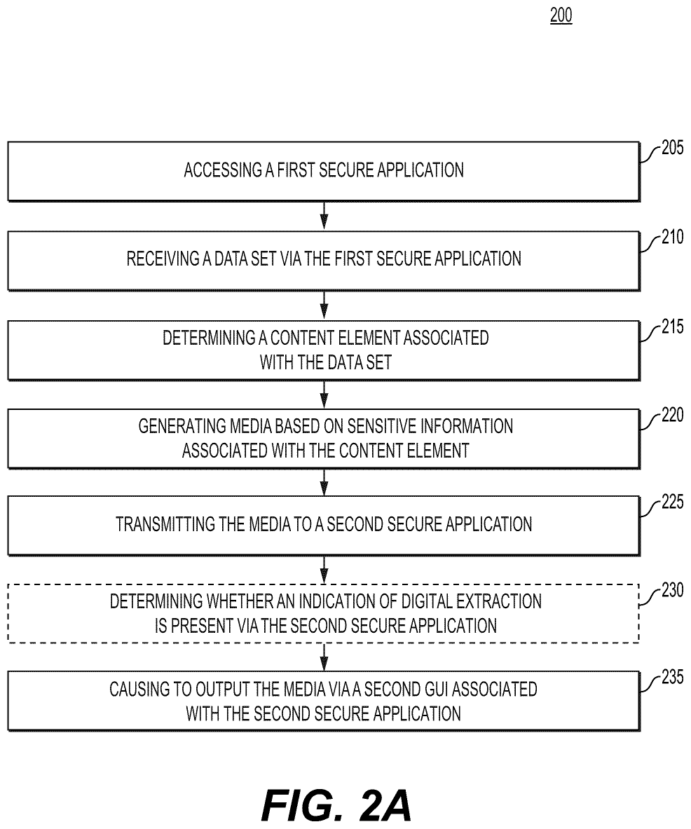

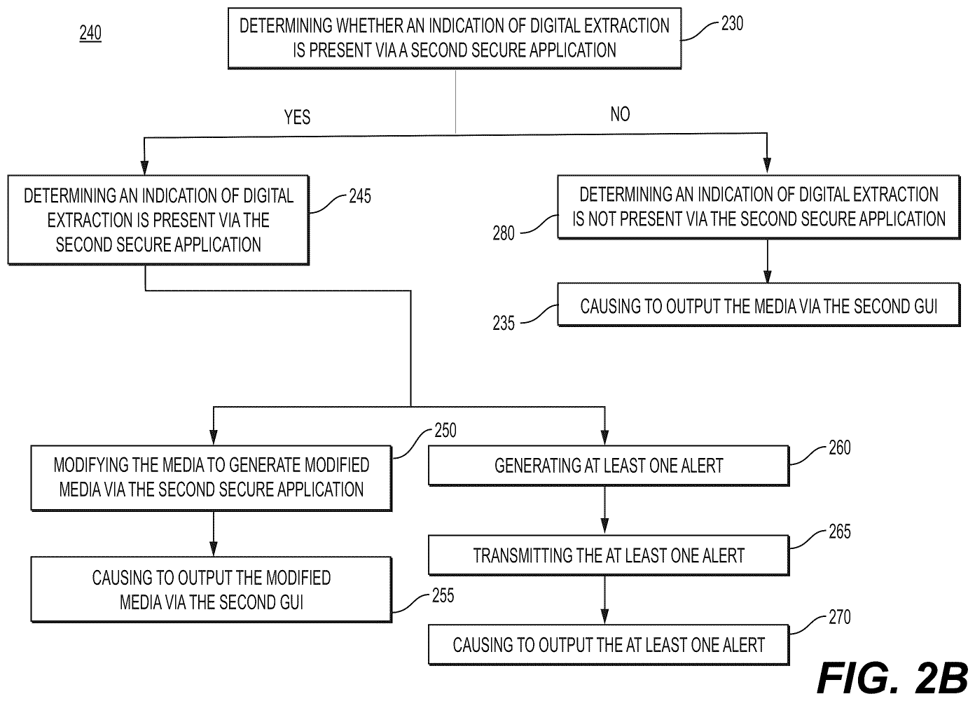

FIGS. 2A-2B depict exemplary methods for dynamically securing transmitted data, according to one or more embodiments. Aspects of the present disclosure relate to systems and methods for protecting one or more content elements included in a message. For example, a system may comprise at least one memory storing instructions, and at least one processor operatively connected to the at least one memory and configured to execute the instructions to perform operations for protecting a content element via dynamically securing transmitted data.

For clarity, the description below refers to user 105 and the systems of user device 110—as depicted in FIG. 1—as first systems (e.g., first user 105, first user device 110, first secure application 111, first local data storage 112, first GUI 113), and to user 115 and the systems of user device 120 as second systems (e.g., second user 115, second user device 120, second secure application 121, second local data storage 122, second GUI 123). It should be noted that this description is intended to provide clarification as to the relationship between the devices in applying the methods described herein and is intended to be non-limiting.

At step 205 of method 200, a first secure application may be accessed. As discussed herein, the first secure application may be downloaded, embedded, stored in a memory or repository of, etc. to the user device (e.g., user device 110). For example, the first secure application may be an application that user 105 has downloaded to user device 110. In another example, the first secure application may be embedded in a data transmission application (e.g., a messaging application) of user device 110. In some embodiments, the first secure application (e.g., secure application 111) may be accessed via a user (e.g., user 105) providing at least one user input via a GUI (e.g., GUI 113) to access the first secure application.

In some embodiments, the operations may include accessing the secure application (e.g., via the messaging application of user device 110). For example, the operations may include accessing a messaging application (e.g., a first messaging application) via a first computing device (e.g., user device 110). In some aspects, the messaging application (e.g., the first messaging application) may include an embedded secure application (e.g., a first secure application 111).

At step 210, at least one data set may be received. The description and examples below refer to a data set for clarity, but it should be noted that any number of data sets may be received. As discussed herein, a data set may include at least one of text data, image data, video data, or audio data. The data set may include a content element. The operations may include receiving (e.g., via first secure application 111) the content element. The operations may include transmitting (e.g., via the first messaging application, first secure application 111, first local data storage 112, etc.) the content element to a second secure application (e.g., second secure application 121), as discussed in more detail below. The content element may include sensitive information. A user (e.g., user 105) may wish to protect the sensitive information, e.g., by preventing digital extraction of the sensitive information.

The data set may be received in response to an input, e.g., in response to a user input. In some embodiments, a user may provide the data set via a user input. For example, user 105 may provide a user input, such as a natural language prompt, via GUI 113. The natural language prompt may include the data set as text, such as “My password is XYZ.” The textual data set (e.g., “My password is XYZ”) may be transmitted from GUI 113 to be received via first secure application 111 (e.g., via a first messaging application that includes first secure application 111).

In some embodiments, a user may request retrieval of the data set via a user input. User 105 may provide the user input, such as at least one retrieval input, via GUI 113. The at least one retrieval input may include at least one input from the user that may instruct the first messaging application or first secure application 111 to access a storage system (e.g., local data storage 112 or data storage 135) to retrieve the data set. For example, as discussed herein, local data storage 112 may include an image storage application, among other possibilities. Based on the retrieval inputs, at least one of an image, video, or audio recording may be requested, retrieved, or transmitted from the image storage application (e.g., local data storage 112) to first secure application 111 (e.g., the first messaging application that may include first secure application 111). In another example discussed herein, local data storage may include a notes application, among other possibilities. Based on the retrieval inputs, at least one of text, image, video, or audio may be requested, retrieved, or transmitted from the notes application (e.g., local data storage) to first secure application 111 (e.g., the first messaging application that may include first secure application 111).

The data set received via the first messaging application or first secure application 111 may be transmitted to application server 125. In some embodiments, the data set may be received directly via application server 125.

At step 215, a content element associated with the data set may be determined (e.g., via application server 125). As discussed herein, the data set may include a content element, and the content element may include sensitive information. In some embodiments, the data set may be analyzed to determine at least one content element and sensitive information associated with each of the at least one content element. As discussed herein, the data set may be analyzed based on the data set format (e.g., text, image, video, audio, etc.), the data set source (e.g., natural language prompt, a data storage system, etc.), or any other relevant aspect for analysis. For example, where the data set includes an image, the image may be analyzed (e.g., via application server 125) using optical character recognition (“OCR”) to convert the image to machine-readable text. The machine-readable text may be analyzed (e.g., via application server 125) for sensitive information.

At step 220, media may be generated based on the sensitive information associated with the content element. As discussed herein, the media may be substantially transparent, an image (e.g., a still image), a video (e.g., a single frame-looped video), etc. The media may be generated based on at least one of the data set, the content element, the sensitive information, etc. For example, the media may be generated (e.g., via application server 125) as a single frame-looped video based on the determined sensitive information or content element.

In some embodiments, the media may be generated to include DRM protection(s). For example, the operations may include, generating (e.g., via application server 125) a video (e.g., a single frame-looped video), where the video represents the content element and is protected using digital rights management technologies.

At step 225, the media (e.g., DRM-protected media) may be transmitted to a second secure application (e.g., second secure application 121). In some embodiments, the media may be transmitted in response to a user input (e.g., a user input from user 105 via GUI 113), such as the user selecting a “send” icon in the first messaging application, etc. For example, the operations may include transmitting (e.g., via application server 125) the media (e.g., a single frame-looped video, a DRM-protected a single frame-looped video, etc.) to a second computing device (e.g., second user device 120) in response to a user input (e.g., from first user 105 via GUI 113). In some embodiments, the media may be transmitted upon generation (e.g., via application server 125). For example, the operations may include automatically transmitting (e.g., via application server 125) the media (e.g., a single frame-looped video, a DRM-protected a single frame-looped video, etc.) to a second computing device (e.g., second user device 120) upon generation of the media (e.g., via application server 125). The media may be received at second user device 120 via a second messaging application, second secure application 121, or second local data storage 122.

As discussed herein, the second secure application 121 may be downloaded, embedded, etc. to the user device (e.g., user device 120). For example, the second secure application 121 may be an application that user 115 has downloaded to user device 120. In another example, the second secure application 121 may be embedded in a data transmission application (e.g., a messaging application, etc.) of user device 120. In some embodiments, the second secure application (e.g., secure application 121) may be accessed via a user (e.g., user 115) providing at least one user input via a GUI (e.g., GUI 123) to access the second secure application.

In some embodiments, the operations may include accessing the secure application (e.g., via the messaging application of second user device 120). For example, the operations may include accessing a messaging application (e.g., a second messaging application) via a second computing device (e.g., user device 120). In some aspects, the messaging application (e.g., the second messaging application) may include an embedded secure application (e.g., a second secure application 121).

Optionally, at step 230, the presence of an indication of digital extraction may be determined (e.g., via application server 125). As depicted in FIG. 2B, at step 245 of method 240, it may be determined that an indication of digital extraction is present. In some embodiments, the presence of the indication of digital extraction may be determined based on at least one indirect factor, such as user inputs, enabled settings, concurrently operating applications, etc. For example, if a user input that may be indicative of screenshotting is detected, such as simultaneously pressing and releasing the lock button and the volume up button (e.g., on second user device 120), an indication of digital extraction may be determined to be present. In another example, if it is determined that a screen recording feature is enabled in the settings of second user device 120, an indication of digital extraction may be determined to be present.

At step 250, upon determining an indication of digital extraction is present, the media may be modified (e.g., via application server 125). In some embodiments, the media (e.g., DRM-protected media) may be modified such that the sensitive information (e.g., of the data set, the content element, etc.) may be made substantially not visible (e.g., when output via second GUI 123). For example, the media may be modified from a substantially transparent single frame-looped video to a substantially opaque single frame-looped video or a substantially opaque image. The modified media (e.g., the modified DRM-protected media) may be transmitted (e.g., to second GUI 123 via application server 125) to be caused to be output.

At step 255, the modified media may be caused to be output via the second GUI (e.g., GUI 123). The modified media (e.g., the DRM-protected modified media) may be received at GUI 123 from application server 125. As discussed herein, the modified media may be caused to be output via second GUI 123 such that the sensitive information may be substantially obscured to second user 115.

Alternatively or in addition to modifying the media at step 250, upon determining an indication of digital extraction is present, at least one alert may be generated at step 260. In some embodiments, step 250 and step 260 may occur in series (e.g., step 250 then step 260 or step 260 then step 250) or in parallel (e.g., step 250 and step 260 occurring substantially simultaneously). The at least one alert may be generated based on at least one of the indication of digital extraction, the data set, the content element, the sensitive information, the media, the modified media, an intended recipient individual (e.g., user 105, user 115, user 125, etc.), etc. As discussed herein, the at least one alert may include any suitable information, such as a message (e.g., a message to user 105, a message to user 115, a message to user 125, etc.), the indication of digital extraction, etc.

For example, a first alert may be generated for first user 105 if the presence of an indication of digital extraction is detected (e.g., via second secure application 121). The first alert may be generated to include a message (e.g., natural language text, etc.) directed to the relevant individual (e.g., user 105). An example of a natural language message included in the first alert may include “Your transmitted data may have been compromised.”

In another example, a second alert may be generated for user 125 if the presence of an indication of digital extraction is detected (e.g., via first secure application 111 or second secure application 121). The second alert may be generated to include a message (e.g., natural language text, etc.) directed to the relevant individual (e.g., user 125). An example of a natural language message included in the second alert may include “Customer A's information may be compromised,” etc.

At step 265, the at least one alert may be transmitted to at least one user device. In some embodiments, the at least one alert may be transmitted (e.g., to at least one aspect of environment 100) based on the at least one of the indication of digital extraction, the data set, the content element, the sensitive information, the media, the modified media, the intended recipient individual, etc. For example, the first alert (having been generated based on user 105 as the intended recipient), may be transmitted to a user device associated with user 105 (e.g., first secure application 111 of first user device 110). In a further example, the second alert (having been generated based on user 125 as the intended recipient), may be transmitted to a user device associated with user 125 (e.g., DRM-protection system 131 of user device 130).

At step 270, the at least one alert may be caused to be output. In some embodiments, the at least one alert may be output based on the user device to which it has been transmitted (e.g., at step 265). For example, the first alert (having been transmitted to first secure application 111 of first user device 110), may be caused to be output via first GUI 113. In another example, the second alert (having been transmitted to DRM-protection system 131 of user device 130), may be caused to be output via GUI 132.

At step 280, it may be determined that an indication of digital extraction is not present. In some embodiments, determining that an indication of digital extraction is not present may be based on the absence of the indication of digital extraction. For example, if the indication of digital extraction is not determined or received (e.g., via second secure application 121 or application server 125), it may be assumed that the indication of digital extraction is not present. In other words, it may be assumed that the indication of digital extraction is not present unless the indication of digital extraction is affirmatively determined or received.

In some embodiments, determining that an indication of digital extraction is not present may be based on a determination that the at least one indirect factor discussed in relation to step 245 are absent. For example, if a user input that may be indicative of screenshotting (e.g., simultaneously pressing and releasing the lock button and the volume up button via second user device 120) is not detected, an indication of digital extraction may be determined to be absent. In another example, if it is determined that a screen recording feature is not enabled in the settings of second user device 120, an indication of digital extraction may be determined to be absent.

At step 235, also shown in FIG. 2A, the media (e.g., the DRM-encrypted media) may be caused to be output via second GUI 123. In some embodiments, the media may be caused to be output upon a determination that an indication of digital extraction is not present. The media or the DRM-encrypted media may be caused to be output such that the sensitive information is substantially visible via second GUI 123 (e.g., to second user 115).

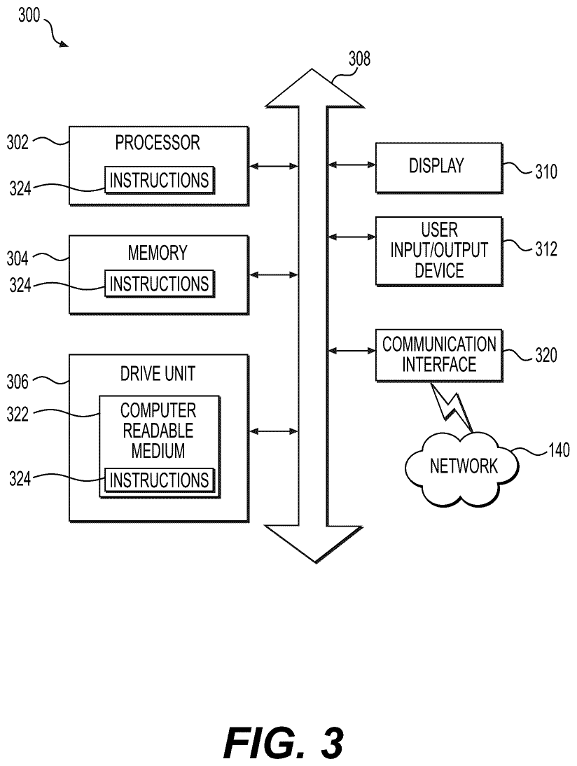

FIG. 3 depicts a simplified functional block diagram of a computer 300 that may be configured as a device for executing the methods disclosed here, according to exemplary embodiments of the present disclosure. For example, the computer 300 may be configured as a system according to exemplary embodiments of this disclosure. In various embodiments, any of the systems herein may be a computer 300 including, for example, a data communication interface 320 for packet data communication. The computer 300 also may include a central processing unit (CPU) 302, in the form of one or more processors, for executing program instructions. The computer 300 may include an internal communication bus 308, and a storage unit 306 (such as ROM, HDD, SDD, etc.) that may store data on a computer readable medium 322, although the computer 300 may receive programming and data via network communications. The computer 300 may also have a memory 304 (such as RAM) storing instructions 324 for executing techniques presented herein, although the instructions 324 may be stored temporarily or permanently within other modules of computer 300 (e.g., processor 302 or computer readable medium 322). The computer 300 also may include input and output ports 312 or a display 310 to connect with input and output devices such as keyboards, mice, touchscreens, monitors, displays, etc. The various system functions may be implemented in a distributed fashion on a number of similar platforms, to distribute the processing load. Alternatively, the systems may be implemented by appropriate programming of one computer hardware platform.

Program aspects of the technology may be thought of as “products” or “articles of manufacture” typically in the form of executable code or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

It should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Thus, while certain embodiments have been described, those skilled in the art will recognize that other and further modifications may be made thereto without departing from the spirit of the invention, and it is intended to claim all such changes and modifications as falling within the scope of the invention. For example, functionality may be added or deleted from the block diagrams and operations may be interchanged among functional blocks. Steps may be added or deleted to methods described within the scope of the present invention. The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations are possible within the scope of the disclosure. Accordingly, the disclosure is not to be restricted except in light of the attached claims and their equivalents.

What is claimed is:

1. A method for dynamically securing transmitted data, the method comprising:
accessing, via a first user device, a first secure application;
receiving, via the first secure application, a data set, wherein the data set includes at least one of text data, image data, video data, or audio data;
determining, via a first application server associated with the first secure application, a content element associated with the data set, wherein the content element includes sensitive information;
generating, via the first application server, media based on the sensitive information, wherein the media is encrypted to include digital rights management (“DRM”) protection;
transmitting, to a second secure application associated with a second user device, the media; and
causing to output the media via a graphical user interface (“GUI”) associated with the second user device.

2. The method of claim 1, further comprising accessing, via the first user device, the first secure application via a first data transmission application.

3. The method of claim 2, wherein the first secure application is embedded in the first data transmission application and the second secure application is embedded in a second data transmission application.

4. The method of claim 1, wherein receiving the data set further comprises:
receiving, via a GUI associated with the first user device, a natural language prompt, wherein the natural language prompt is input by a first user as a user input; and
transmitting, to the first application server, the natural language prompt.

5. The method of claim 1, wherein receiving the data set further comprises:
accessing, via the first application server, a data storage application;
requesting, via the first application server, the data set from the data storage application; and
transmitting, to the first application server, the data set from the data storage application.

6. The method of claim 1, wherein causing to output the media via the GUI associated with the second user device further comprises:
determining, via a second application server associated with the second secure application, whether an indication of digital extraction is present; and
upon determining via the second application server the indication of digital extraction is not present, causing to output the media via the GUI associated with the second user device.

7. The method of claim 1, further comprising:
determining, via a second application server associated with the second secure application, whether an indication of digital extraction is present;
upon determining via the second application server the indication of digital extraction is present, modifying the media to generate a modified media, wherein the media is modified such that the sensitive information substantially not visible; and
causing to output the modified media via the GUI associated with the second user device.

8. The method of claim 7, further comprising:
upon determining via the second application server the indication of digital extraction is present, generating a first alert via the second application server;
transmitting the first alert to the first secure application; and
causing to output the first alert via a GUI associated with the first secure application.

9. The method of claim 7, further comprising:
upon determining via the second application server the indication of digital extraction is present, generating a second alert;
transmitting the second alert to a DRM-protection system; and
causing to output the second alert via a GUI associated with the DRM-protection system.

10. A system, the system comprising:
at least one memory storing instructions; and
at least one processor operatively connected to the memory, and configured to execute the instructions to perform operations for dynamically securing transmitted data, the operations including:
accessing, via a first user device, a first secure application;
receiving, via the first secure application, a data set, wherein the data set includes at least one of text data, image data, video data, or audio data;
determining, via a first application server associated with the first secure application, a content element associated with the data set, wherein the content element includes sensitive information;
generating, via the first application server, media based on the sensitive information, wherein the media is encrypted to include digital rights management (“DRM”) protection;
transmitting, to a second secure application associated with a second user device, the media; and
causing to output the media via a graphical user interface (“GUI”) associated with the second user device.

11. The system of claim 10, wherein the operations further include accessing, via the first user device, the first secure application via a first data transmission application.

12. The system of claim 11, wherein the first secure application is embedded in the first data transmission application and the second secure application is embedded in a second data transmission application.

13. The system of claim 10, wherein receiving the data set further comprises:
receiving, via a GUI associated with the first user device, a natural language prompt, wherein the natural language prompt is input by a first user as a user input; and
transmitting, to the first application server, the natural language prompt.

14. The system of claim 10, wherein receiving the data set further comprises:
accessing, via the first application server, a data storage application;
requesting, via the first application server, the data set from the data storage application; and
transmitting, to the first application server, the data set from the data storage application.

15. The system of claim 10, wherein causing to output the media via the GUI associated with the second user device further comprises:
determining, via a second application server associated with the second secure application, whether an indication of digital extraction is present; and
upon determining via the second application server the indication of digital extraction is not present, causing to output the media via the GUI associated with the second user device.

16. The system of claim 10, wherein the operations further include:
determining, via a second application server associated with the second secure application, whether an indication of digital extraction is present;
upon determining via the second application server the indication of digital extraction is present, modifying the media to generate a modified media, wherein the media is modified such that the sensitive information substantially not visible; and
causing to output the modified media via the graphical user interface (“GUI”) associated with the second user device.

17. The system of claim 16, wherein the operations further include:
upon determining the indication of digital extraction is present, generating a first alert via the second application server;
transmitting the first alert to the first secure application; and
causing to output the first alert via a GUI associated with the first secure application.

18. The system of claim 16, wherein the operations further include:
upon determining via the second application server the indication of digital extraction is present, generating a second alert;
transmitting the second alert to a DRM-protection system; and
causing to output the second alert via a GUI associated with the DRM-protection system.

19. A method for dynamically securing transmitted data, the method comprising:
accessing, via a first user device, a first secure application via a first data transmission application, wherein the first secure application is embedded in the first data transmission application;
receiving, via the first secure application, a data set, wherein the data set includes at least one of text data, image data, video data, or audio data;
determining, via a first application server associated with the first secure application, a content element associated with the data set, wherein the content element includes sensitive information;
generating, via the first application server, media based on the sensitive information, wherein the media is encrypted to include digital rights management (“DRM”) protection;
transmitting, to a second secure application associated with a second user device, the media;
determining, via a second application server associated with the second secure application, whether an indication of digital extraction is present, wherein the second secure application is embedded in a second data transmission application; and
upon determining via the second application server the indication of digital extraction is not present, causing to output the media via a graphical user interface (“GUI”) associated with the second user device.

20. The method of claim 19, further comprising:
determining, via a second application server associated with the second secure application, whether an indication of digital extraction is present;
upon determining via the second application server the indication of digital extraction is present, modifying the media to generate a modified media, wherein the media is modified such that the sensitive information substantially not visible; and
causing to output the modified media via a GUI associated with the second user device.
